(19) United States
(12) Patent Application Publication
(10) Pub. No.: US 2024/0160952 A1
(43) Pub. Date: May 16, 2024

(54) TARGET-BASED SHORTEST PATH EXTRACTING METHOD AND DEVICE THEREOF

(71) Applicant: AUROS TECHNOLOGY, INC., Hwaseong-si (KR)

(72) Inventors: Hanmire KIM, Hwaseong-si (KR); Dong-Geon JO, Hwaseong-si (KR)

(73) Assignee: AUROS TECHNOLOGY, INC., Hwaseong-si (KR)

(21) Appl. No.: 18/200,260

(22) Filed: May 22, 2023

(30) Foreign Application Priority Data
Nov. 10, 2022 (KR) 10-2022-0149246

(51) Int. Cl. G06N 5/01

(52) U.S. Cl. CPC G06N 5/01

(57) ABSTRACT

There is provided a target-based shortest path extracting method. The method includes recognizing three or more sites within a designated area of a target and setting a start site among the recognized sites; extracting a tree graph by connecting sites within the designated area, starting with the start site; and extracting the shortest path between sites within the designated area of the target by connecting tree lines of the tree graph, starting with the start site.

### CROSS-REFERENCE TO PRIOR APPLICATION

This application is claims priority to Korean Patent Application No. 10-2022-0149246 (filed on Nov. 10, 2022), which is hereby incorporated by reference in its entirety.

### BACKGROUND

The present disclosure relates to a target-based shortest path extracting device that may the shortest path regardless of the number of sites within a target, and a method thereof.

In calculating the shortest distance, the number of causes that increase when calculating all distances between sites is “(Number of sites−1)!” As the number of sites increases, the number of cases increases to an astronomical number, which makes it virtually impossible to calculate.

Therefore, there is a need for an algorithm capable of extracting the shortest path even if the number of sites increases.

### SUMMARY

Accordingly, one objective of the present disclosure is invented to solve the above-noted disadvantages of the prior art, and to provide a target-based shortest path extracting device that may extract the shortest path regardless of the number of sites in a target, and a method thereof.

Further, another objective of the present disclosure is to provide a target-based shortest path extracting device that may reduce a path searching time by minimizing unnecessary site searching, and a method thereof.

Objects of the present invention are not limited to the above-described objects, and other objects and advantages of the present invention will be understood by the following description and will be more definitely understood through the embodiments of the present invention. It is also to be easily understood that the objectives and advantages of the present invention may be realized and attained by means and a combination thereof described in the appended claims.

A target-based shortest path extracting method according to an embodiment may include a step of recognizing three or more sites within a designated area of a target and setting a start site among the recognized sites; a step of extracting a tree graph by connecting sites within the designated area, starting with the start site; and a step of extracting the shortest path between sites within the designated area of the target by connecting tree lines of the tree graph, starting with the start site.

In another aspect of the present disclosure, a target-based shortest path extracting device according to an embodiment may include a processor comprising instructions implementing an algorithm for extracting the shortest path between sites within a target. The processor may recognize three or more sites within a designated area of a target, set one of the recognized sites as a start site, extracts a tree graph by connecting sites within the designated area, starting with the start site, and extract the shortest path between the sites within the designated area of the target by connecting tree lines of the tree graph, starting with the start site.

The target-based shortest path extracting device and the method thereof according to the embodiments may extract the shortest path regardless of the number of sites within the target.

In addition, the target-based shortest path extracting device and the method thereof may reduce the path searching time by minimizing unnecessary site searching.

In addition, the target-based shortest path extracting device and the method thereof may be applied to various fields such as ultra-high-density integrated circuit design.

In addition to the above-described effects, specific effects of the present invention will be described together with the following detailed description for implementing the present invention.

### BRIEF DESCRIPTION OF THE DRAWINGS

FIG. 1 is a block view to describe a field-based movement process.

FIG. 2 is a block view to describe a target-based movement process.

FIG. 3 is a view showing an example of extracting a tree graph without regression in a target-based shortest path extracting method according to an embodiment.

FIG. 4 is a view showing an example of extracting the shortest path of a target for all sites within a designated region in a target-based shortest path extracting method according to an embodiment.

FIG. 5 is a view to describe a target-based shortest path extracting device and a method thereof according to an embodiment.

### DETAILED DESCRIPTION

The above objects, features and advantages will be described later in detail with reference to the accompanying drawings, and accordingly, those skilled in the art to which the present invention belongs will be able to easily implement the technical idea of the present invention. In describing the present invention, if it is determined that the detailed description of the known technology related to the present invention may unnecessarily obscure the subject matter of the present invention, the detailed description will be omitted. Hereinafter, preferred embodiments according to the present invention will be described in detail with reference to the accompanying drawings. In the drawings, the same reference numerals are used to indicate the same or similar components.

The terms “first”, “second” and the like are used herein only to distinguish one component from another component. Thus, the components should not be limited by the terms. Certainly, a first component can be a second component unless stated to the contrary.

Hereinafter, a target-based shortest path extracting method that may extract the shortest path regardless of the number of targets will be disclosed.

Before describing the target-based shortest path extracting method that may extract the shortest path regardless of the number of targets, the meaning of terms used in the specification will be defined.

In the detailed description, a site may be defined as a site that has a location or coordinates within a target.

A tree line may be defined as a line that connects sites. The number displayed next to the tree line indicates a distance between sites.

A site index may be defined as a unique non-duplicate identifier within a target that allows each site to be specified. For example, a plurality of sites may exist in a target, and the sites may be specified and defined by a number of non-duplicate values, respectively.

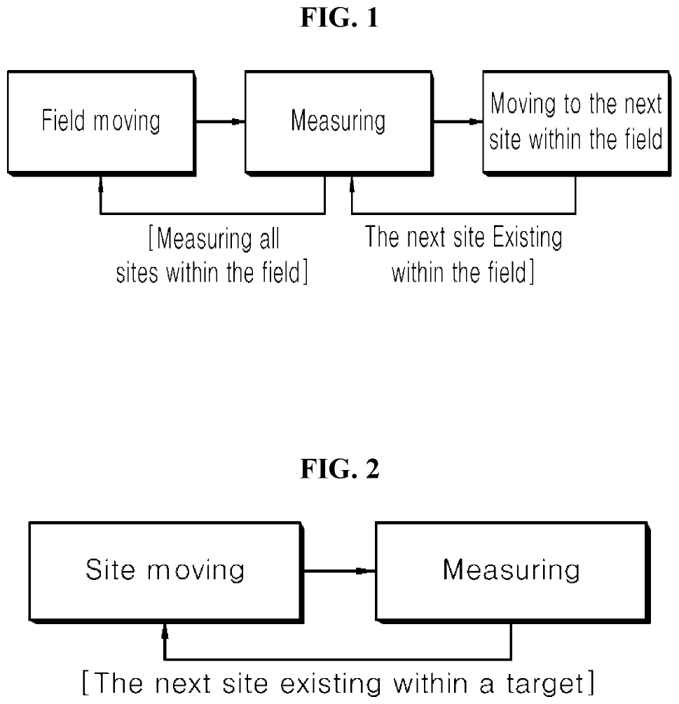

FIG. 1 is a block view to describe a field-based movement process.

In the field-based movement process, a sequence in an order of Target, Field, and Site proceeds. A sequence from a standpoint of a state may repeatedly proceed in an order of moving a field within a target, measuring sites within the field, and moving to a site in the next field.

This field-based movement process cannot suggest a reasonable movement method for all coordinates within the target.

FIG. 2 is a block view to describe a target-based movement process.

A sequence proceeds based on all site coordinates in the target. In this method, the field is not considered when moving the site and the shortest distance is calculated based only on the entire coordinates within the target.

Since the path is set based on the entire coordinates, an effective shortest distance algorithm may be used and equipment performance may be improved by improving Move Acquire Measurement Time (MAM TIME).

According to this embodiment, the shortest path between sites may be extracted regardless of the number of sites within a target.

In calculating the shortest distance, the number of causes that increase when calculating all distances between sites is “(Number of sites−1)!” As the number of sites increases, the number of cases increases to an astronomical number, which makes it virtually impossible to calculate. To substantially solve this problem, a separate algorithm is required.

For example, a wafer may be divided into a plurality of fields and a field includes a plurality of units. A target-based shortest path extracting algorithm may be used to extract the shortest path between units within a wafer.

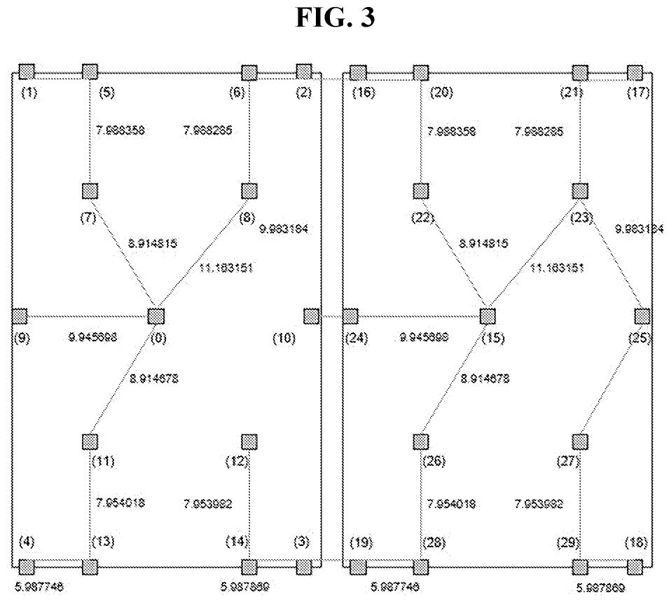

FIG. 3 is a view showing an example of extracting a tree graph without regression in a target-based shortest path extracting method according to an embodiment.

The method of extracting the shortest path based on the target according to the embodiment may require Minimum Spanning Tree (MST) which is a tree graph without regression, to calculate the shortest distance. For this purpose, a first algorithm may be used.

Using the first algorithm, sites belonging to the shortest distance are obtained from a first start node, connected and included in a group. After that, sites within the shortest distance to the connected sites are included in a group and this process is repeated until all sites within a designated area of the target are connected.

This process may be performed for all sites within an entire region of the target or for only sites within an area designated as necessary area.

For each site, an index may be set with a unique identification factor without duplication in the target to specify a site. For example, a number may be set as an index value for each site. For example, a site with a site index value of 0 may be set as the first start node of a site. However, a site with a value other than 0 may be set as the first start node if necessary.

In FIG. 3, a tree line is a line connecting sites and a numerical value displayed next to the tree line is a distance between sites.

For example, the first algorithm is configured to extract a tree graph through following processes.

First, a first site located at the shortest distance from the start site is obtained and the first site is connected to the start site. A first tree line including the start site and the first site is generated. Sites included in the first tree line may be defined as a first group.

A second site located at the shortest distance from the first tree line is obtained and the second line is connected to the first tree line. A second tree line including the first tree line and the second site is generated. Sites included in the second tree line may be defined as a second group.

The above process is repeated until a plurality of sites, preferably, all sites within a designated area are connected, and a tree graph without regression may be extracted.

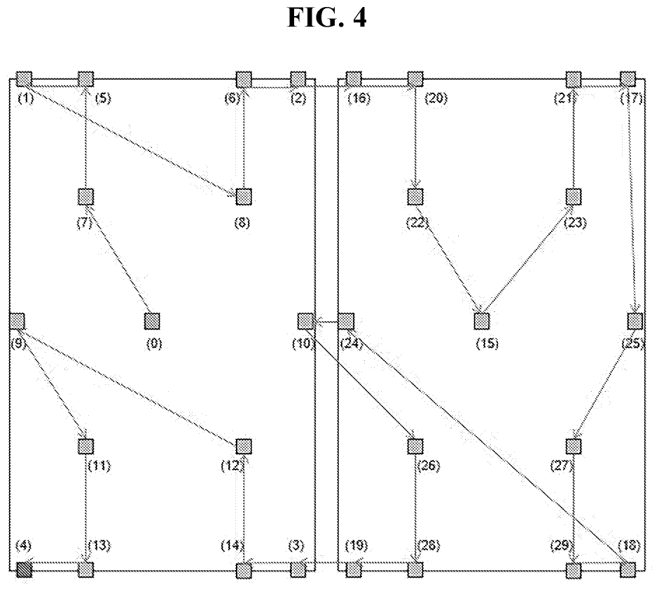

FIG. 4 is a view showing an example of extracting the shortest path of a target for all sites within a designated region in a target-based shortest path extracting method according to an embodiment.

A target-based shortest path extracting method according to an embodiment may extract the final shortest distance between sites based on a second algorithm.

The second algorithm connects the lowest site index in several tree lines to the encountered site, whenever encountering a site. When the tree line ends, the second algorithm connects a tree line, which has the lowest site index among the tree lines not connected after recurring to the previous site, and the second algorithm repeats the process until passing all sites within the designated area of the target.

Through the above-noted process, the final shortest distance for all the sites within the designated area of the target may be extracted.

For example, the second algorithm may extract the final shortest distance between sites through following process.

First, a third tree line including the lowest site index among tree lines connected with a first start site may be connected to the first start site.

A fourth tree line having the lowest site index among tree lines connected with the third tree line may be connected to the third tree line.

When no tree line is connected to the fourth tree line, the second algorithm returns to the previous site and connects a fifth tree line having the lowest site index among the not-connected tree lines to the fourth tree line.

The second algorithm repeats this process until encountering all sites within a designated region of the target and extracts the shortest path for all sites within the target.

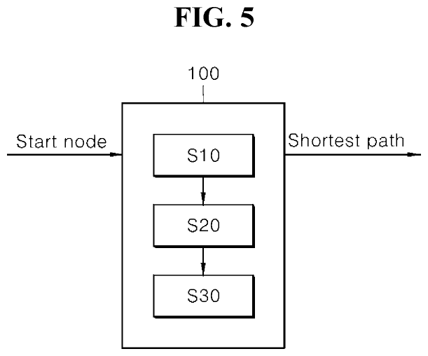

FIG. 5 is a view to describe a target-based shortest path extracting device and a method thereof according to an embodiment.

The target-based shortest path extracting device according to an embodiment may include a processor. The processor 100 may include instructions for performing an algorithm implemented to extract the shortest path, and a memory.

First, the processor 100 may receive a signal for setting a start site from a user. The processor 100 may set one of sites within a target as a start site based on the input setting signal (S10). For example, any one of the sites may be set as the start site. Or, one site having the lowest index value may be set as the start site.

Next, the processor 100 may connect all sites within a designated area of the target, starting from the start site and extract a tree graph without regression based on the first algorithm (S20).

The processor 100 may determine a first site at the shortest distance from the start site and connect the first site to the start site. The processor 100 may generate a first tree line including the start site and the first site.

The processor 100 may determine a second site at the shortest distance from the first tree line and connect the second site to the first tree line. The process 100 may generate a second tree line including the first tree line and the second site.

The processor 100 may repeatedly extract a non-regression tree graph until all sites within a designated area of the target.

Next, based on the second algorithm, the processor 100 may connect tree lines of the tree graph from the start and extract the shortest distance between sites (S30).

The processor 100 may connect a third tree line, which has the lowest site index among the tree lines connected with the first start site, with the first start site. The processor 100 may connect a fourth tree line, which has the lowest site index among the tree lines connected with the third tree line, with the third tree line.

when determining that there is no tree line connected with the fourth tree line, the processor 100 may connect a fifth tree line, which has the lowest site index among the tree lines not connected after recurring to the previous site, with the fourth tree line. The processor 100 may repeatedly extract the shortest paths between all the sites within a designated area of the target until passing all the sites within the designated area of the target.

Meanwhile, the tree graph may consist of a site group and a tree line group. The tree line may represent a connection relationship between two sites. When two sites in the tree line are ranked, one site of them with the highest ranking may be named the senior site and the site with the lowest ranking may be named the subordinate site.

When the tree lines are ranked, they may be named a first rank tree line, a second rank tree line, etc. according to the rank.

The tree line may be weighted according to a distance between the sites, and the tree lines may be connected based on the weights, to extract the shortest path between all the sites within the designated area of the target.

For example, the tree graph may be applied to various fields. In case of social network analysis, people may be defined as sites and friends relationships as tree lines. The tree graph may be used to identify other friends who are connected through various levels of friendship.

Alternatively, the tree graph may be applied to fining a path from a start city to a target city by defining cities as sites and roads between cities as tree lines. The tree graph is a series of tree lines and the start of the first tree line is defined as the start site and the target site. The shortest path may indicate a path having the shortest distance among paths starting from the start site and reaching the target site when the start site and the target site are given.

Meanwhile, in this embodiment, sites for all targets may be recognized and the shortest distance between the sites may be calculated.

As one example, sites may be recognized by performing a sequence based on coordinates of entire sites within the target and the shortest path may be extracted.

As another example, all the sites within the target may be divided into a plurality of areas. The sites may be recognized by performing a sequence based on coordinates of sites within each of the areas and the shortest path within the area may be extracted.

As described above, the target-based shortest path extracting method may include a step of recognizing three or more sites within a designated area of a target and setting a start site among the recognized sites, a step of extracting a tree graph by connecting sites within a area designated, starting with the start site, and a step of extracting the shortest path for the sites within the designated area of the target, starting with the start site by connecting tree lines of a tree graph.

The tree graph extracting step may include a step of connecting a first site located at the shortest distance from the start site with the start site and generating a first tree line including the start site and the first site, a step of connecting a second site located at the shortest distance from the first tree line with the first tree line and generating a second tree line including the first tree line and the second site, and a step of repeatedly extracting a non-regression tree graph by until all sites within a designated region of a target through the same process.

The shortest path extracting step may include a step of connecting a third tree line, having the lowest site index among the tree lines connected with the first start site, with the first starts; a step of connecting a fourth tree line, having the lowest site index among the tree lines connected with the third tree line, with the third tree line; a step of connecting a fifth tree line having the lowest site index among the tree lines not connected after recurring to the previous site if there is no tree line connected with the fourth tree line; and a step of repeatedly extracting the shortest path between all the sites within a designated area of the target until passing all the sites within the designated area of the target.

The start site setting step may set one of the sites as the start site based on an input setting signal.

Hence, the target-based shortest path extracting device according to an embodiment may include a processor including instructions for implementing an algorithm configured to extract the shortest path between all sites within a target, and a processor. The processor may recognize three or more sites within a designated area of the target, set a start site among the recognized sites, extract a tree graph from the start site by connecting the sites within the designated area, and extract the shortest path between the sites within the designated area of the target by connecting tree lines of the tree graph, starting with the start site.

As described above, the target-based shortest path extracting device and the method thereof according to the embodiments may extract the shortest path regardless of the number of sites within the target.

In addition, the target-based shortest path extracting device and the method thereof may reduce the path searching time by minimizing unnecessary site searching.

In addition, the target-based shortest path extracting device and the method thereof may be applied to various fields such as ultra-high-density integrated circuit design.

Although the present invention has been described with reference to the exemplified drawings, it is to be understood that the present invention is not limited to the embodiments and drawings disclosed in this specification, and those skilled in the art will appreciate that various modifications are possible without departing from the scope and spirit of the present invention. Further, although the operating effects according to the configuration of the present invention are not explicitly described while describing an embodiment of the present invention, it should be appreciated that predictable effects are also to be recognized by the configuration.

1. A target-based shortest path extracting method comprising:
a step of recognizing three or more sites within a designated area of a target and setting a start site among the recognized sites;
a step of extracting a tree graph by connecting sites within the designated area, starting with the start site; and
a step of extracting the shortest path between sites within the designated area of the target by connecting tree lines of the tree graph, starting with the start site.

2. The target-based shortest path extracting method of claim 1, wherein the tree graph extracting step comprises,
a first tree line generating step of searching a first site located at the shortest distance from the start site and connecting the first site with the start site, and generating a first tree line including the start site and the first site;
a second tree line generating step of searching a second site located at the shortest distance from the first tree line and connecting the second site with the first tree line, and generating a second tree line including the first tree line and the second site; and
a non-regression tree graph extracting step of extracting a tree graph without regression within the designated area by repeating the steps until all sites within the designated area are connected.

3. The target-based shortest path extracting method of claim 2, wherein the shortest path extracting step comprises,
a step of connecting a third tree line having the lowest site index among tree lines connected with the first start site with the first start site;
a step of connecting a fourth tree line, which has the lowest site index among tree lines connected with the third tree line, with the third tree line; and
a step of connecting a fifth tree line, which as the lowest site index among tree lines not connected with the fourth tree line after recurring to the previous site, with the fourth tree line, when no tree line is connected with the fourth tree line.

4. The target-based shortest path extracting method of claim 1, wherein the step of setting the start site sets one of sites recognized within the designated area of the target as the start site based on an input setting signal.

5. A target-based shortest path extracting device comprising:
a processor comprising instructions implementing an algorithm for extracting the shortest path between sites within a target, wherein
the processor recognizes three or more sites within a designated area of a target, sets one of the recognized sites as a start site, extracts a tree graph by connecting sites within the designated area, starting with the start site, and extracts the shortest path between the sites within the designated area of the target by connecting tree lines of the tree graph, starting with the start site.

6. The target-based shortest path extracting device of claim 5, wherein when extracting the tree graph, the processor searches a first site located at the shortest distance from the start site, connects the first site with the start site, and generates a first tree line including the start site and the first site, and
the processor searches a second site located at the shortest distance from the first tree line and connects the second site with the first tree line, and generates a second tree line including the first tree line and the second site, and
the processor extracts a tree graph without regression by repeating the steps until all sites within a designated area of a target are connected.

7. The target-based shortest path extracting device of claim 6, wherein when extracting the shortest path, the processor
connects a third tree line, which has the lowest site index among tree lines connected with the first start site, with the first start site,
connects a fourth tree line, which has the lowest site index among tree lines connected with the third tree line, with the first start site,
connects a fifth tree line, which has the lowest site index among tree lines not connected after recurring to the previous site, with the fourth tree line when not tree line is connected with the fourth tree line, and
extracts the shortest path for all sites within a designated area of a target by repeating the above-processes until passing all sites within a designated area of a target.

8. The target-based shortest path extracting device of claim 5, wherein the processor sets one of the sites recognized within a designated area of the target as the start site based on an input setting signal.
